(19) United States
(12) Patent Application Publication
(10) Pub. No.: US 2006/0229093 A1
(43) Pub. Date: Oct. 12, 2006

(54) Push to talk over cellular (half-duplex) to full-duplex voice conferencing

(76) Inventors: Gurvesh Bhutiani, Milpitas, CA (US); Amitabh Seth, Saratoga, CA (US)

Correspondence Address: IPSG, P.C., P.O. BOX 700640, SAN JOSE, CA, 95170-0640, US

(21) Appl. No.: 11/394,270

(22) Filed: Mar. 29, 2006

Related U.S. Application Data
(60) Provisional application No. 60/666,327, filed on Mar. 29, 2005.

(51) Int. Cl. H04B 7/00; H04Q 7/20

(52) U.S. Cl. 455/518

(57) ABSTRACT

Methods of enabling non-Push-To-Talk (PTT) enabled devices, configured for full-duplex communication, to participate in a PTT-over-Cellular (PoC) session that includes a PTT enabled device, are presented including: detecting start of speech from the non-PTT enabled device; generating a floor control request on behalf of the at least one non-PTT enabled device; negotiating the floor control request based on a device priority; generating a floor control response for the at least one non-PTT enabled device; and generating a first floor control state for the PoC session. In some embodiments, methods further include: buffering RTP packets in a media buffer, the RTP packets corresponding to speech received from the non-PTT enabled device; if the floor control request is granted, sending the RTP packets to the PoC session; and if the floor control request is denied, discarding the RTP packets.

### PRIORITY CLAIM TO PROVISIONAL APPLICATION

A claim for priority is hereby made under the provisions of 35 U.S.C. § 119 for the present application based upon U.S. Provisional Application No. 60/666,327, filed on Mar. 29, 2005 which is incorporated herein by reference.

### FIELD

The present invention relates in general to cellular communication technologies and in particular to communications for allowing users having full-duplex, non-PTT enabled devices (i.e. a SIP phone, a circuit-switched PSTN phone, a circuit-switched mobile phone, and a VOIP phone) to participate in a Push-To-Talk over Cellular session without making changes or additions to the terminal software, or hardware.

### BACKGROUND

Mobile cellular communication is evolving beyond traditional voice telephony towards more sophisticated services, such as Push-To-Talk (PTT). Similar to conventional walkie-talkie communication, PTT enables mobile communication users to send a voice message to one or more recipients over a mobile phone by simply pushing a key (i.e., PTT button).

PTT is typically configured as a half-duplex communication medium. That is, participants may use a single frequency (or channel) for both transmission and reception, but not simultaneously. That is, a participant may either speak or listen, but not both at the same time. In contrast, traditional cellular communication is full-duplex. Full-duplex provides one frequency (or channel) for speaking and a second frequency (or channel) for listening so that both speaking and listening can occur simultaneously. Full-duplex wireless communication mimics traditional land line based telephony.

One particular implementation of PTT is called PTT-over-Cellular (PoC). PoC provides a means of half-duplex like communication between PTT enabled devices to give a “walkie-talkie” type user experience. PoC has been enabled in wireless data networks such as GSM/GPRS and CDMA cellular networks. These wireless data networks may be configured to provide a packet-based voice communication service that enables information to be sent and received across a mobile telephone network. Internet protocols may further facilitate PoC through the use of instant connections. That is, information can be sent or received immediately in accordance with a user's needs when time slots are available at the wireless interface.

PoC also offers enriched services such as the ability to establish ad-hoc, multi-party conference calls, presence status, and list management. The ability to make ad-hoc and pre-arranged Group calls without incurring additional cost is believed to attract a large number of subscribers, particularly in the enterprise space. However, currently, only PTT enabled devices can participate in such PoC sessions. Presently, there is no solution for non-PTT enabled devices to participate in a PoC session that includes PTT enabled devices. The present invention addresses this problem.

It may be appreciated that, for audio/video data transmissions, PoC applications generally require the transmission of signaling packets using a signaling protocol such as Session Initiation Protocol (SIP), and the transmission of data packets using a data protocol such as Real Time Protocol (RTP). SIP is a signaling protocol for Internet conferencing, telephony, presence, events notification, and instant messaging. RTP is an Internet-standard protocol for the transport of real-time data, including audio and video media. RTP may be used for media-on-demand as well as interactive services such as internet telephony. RTP consists of a data and a control portion. The control portion of RTP is typically designated as RTCP.

PoC is discussed in greater detail in the following technical specifications which are incorporated by reference: Push-to-talk over Cellular (PoC), Architecture, PoC Release 2.0, V2.0.8 (2004-06); Push-to-talk over Cellular (PoC), Signaling Flows—UE to Network Interface (UNI), PoC Release 2.0, V2.0.6 (2004-06); and Push-to-talk over Cellular (PoC) User Plane, Transport Protocols, PoC Release 2.0, V2.0.8 (2004-06). Of note, Release 1.0 is also available from the PoC Consortium as well as an upcoming PoC standard from Open Mobile Alliance (OMA). All of these are generally considered native PoC standard and are incorporated herein by reference. Subsequently, UE (User Equipment), such as a PoC enabled cellular phone, supporting either of these standards is called a native PoC client.

Other references pertinent to the invention are:

IP Multimedia Call Control Protocol based on Session Initiation Protocol (SIP) and Session Description Protocol (SDP); Stage 3, Release 6 (3GPP TS 24.229);

“OMA PoC Control Plane Document”, Version 1.0, Open Mobile Alliance™, OMA-TS-POC-ControlPlane-V1_{—}0-20041117-D;

“OMA Push to talk over Cellular (PoC)—User Plane Document”, Version 1.0, Open Mobile Alliance™, OMA-TS_PoC-UserPlane-V1_{—}0-20050308-D;

“Voice Call Continuity between Circuit Switched (CS) and IMS Study, Stage 2, Release 7 (3GPP TR 23.806);

“Combining Circuit Switched Bearers with IMS, Stage 2, Release 6 (3GPP TR 23.899);

“Presence SIMPLE Specification”, Candidate Version 1.0—27 Apr. 2005, Open Mobile Alliance, OMA-TS-Presence_SIMPLE-V1_{—}0-20050427-C;

“RTP Payload for DTMF Digits, Telephony Tones and Telephony Signals”, RFC 2833, IETF; and

“Session Initiation Protocol (SIP) Extension for Event State Publication”, RFC3903, IETF, which are all incorporated herein by reference.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Therefore, methods of enabling non-Push-To-Talk (PTT) enabled devices, configured for full-duplex communication, to participate in a PTT-over-Cellular (PoC) session that includes a PTT enabled device, are presented including: detecting start of speech from the non-PTT enabled device; generating a floor control request on behalf of the at least one non-PTT enabled device; negotiating the floor control request based on a device priority; generating a floor control response for the at least one non-PTT enabled device; and generating a first floor control state for the PoC session. In some embodiments, methods further include: buffering RTP packets in a media buffer, the RTP packets corresponding to speech received from the non-PTT enabled device; if the floor control request is granted, sending the RTP packets to the PoC session; and if the floor control request is denied, discarding the RTP packets. In some embodiments, methods further include: detecting end of speech signal from the non-PTT enabled device; generating a floor control release on behalf of the non-PTT enabled device; and generating a second floor control state for the PoC session.

In other embodiments, systems for enabling non-Push-To-Talk (PTT) enabled devices configured for full-duplex communication, to participate in a PTT-over-Cellular (PoC) session that includes a PTT enabled device are presented including: a full-duplex service configured to provide access to a first communication network for the non-PTT enabled device; a PoC service configured to provide access to a second communication network for the PTT enabled device; a media gateway controller for providing an interface for control signals to pass between the full-duplex service and the PoC service and for providing a control interface for a media gateway, the media gateway configured to provide and receive a control stream and a media stream; a full-duplex PoC proxy coupled with the PoC service for providing an interface for the control stream and the media stream to pass between the full-duplex service and the PoC service. In some embodiments, systems further include a presence server for publishing presence information to the at least one non-PTT enabled device and to the at least one PTT enabled device. In some embodiments, systems further include a web list management server for providing an interface between the PoC service and a web enabled browser, the web browser configured to publish a plurality of addresses and the presence information associated with the PoC session to the at least one non-PTT enabled device. In some embodiments, the full-duplex PoC proxy includes: a voice activity detection component for detecting a speech signal from the non-PTT enabled device; a media buffer for buffering the speech signal; a tone/announcement generator for providing tones and announcements corresponding to a floor control signal received from the PoC service to the non-PTT enabled device; and a full-duplex floor control proxy for receiving the floor control signal.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a network configuration for establishing a PoC session between a circuit-switched full-duplex telephony service and a half-duplex conferencing PoC service in accordance with an embodiment of the present invention;

FIG. 2 is a block diagram of a network configuration for SIP Voice over IP (VOIP) full-duplex endpoint to half-duplex conferencing PoC endpoint in accordance with an embodiment of the present invention;

FIG. 3 is a block diagram of a network configuration for establishing a PoC session between a circuit-switched full-duplex telephony service and a half-duplex conferencing PoC service that includes a presence server and digit map, where the digit map corresponding to key presses is sent to PoC service domain using SIP (control signaling plane) in accordance with an embodiment of the present invention;

FIG. 4 is a block diagram of a network configuration for establishing a PoC session between a circuit-switched full-duplex telephony service and a half-duplex conferencing PoC service that includes a presence server and digit map, where the digit map corresponding to key presses is sent to PoC service domain using RTP (media transport plane) in accordance with an embodiment of the present invention;

FIG. 5 is a block diagram of a network configuration for establishing a PoC session between a VOIP device and a half-duplex conferencing PoC service that includes a presence server in accordance with an embodiment of the present invention;

FIG. 6 is block diagram of a PoC session representation within an MRFP that includes full-duplex PoC termination in accordance with an embodiment of the present invention;

FIG. 7A is a functional block diagram of the Full-Duplex PoC Proxy (FDPP) with voice activity detection for floor control in accordance with an embodiment of the present invention;

FIG. 7B is a functional block diagram of the Full-Duplex PoC Proxy (FDPP) with key press processing for floor control in accordance with an embodiment of the present invention;

FIG. 8 is a data flow diagram depicting message flow when a Full-Duplex UE activates floor control by speaking where the current floor state is IDLE in accordance with an embodiment of the present invention;

FIG. 9 is a data flow diagram depicting message flow when a Full-Duplex UE begins speaking where floor control state is not IDLE and the Full-Duplex UE is not a priority user in accordance with an embodiment of the present invention; and

FIG. 10 is a data flow diagram depicting message flow when a Full-Duplex UE begins speaking where floor control state is not IDLE and the Full-Duplex UE is a priority user in accordance with an embodiment of the present invention.

GLOSSARY

| Term | Description |
|---|---|
| AMR | Adaptive Multi-Rate Speech Codec |
| AS | Application Server |
| CS | Circuit Switching |
| DTMF | Dual-tone Multi-frequency signaling |
| EPA | Event Publication Agent |
| EVRC | Enhanced Variable Rate Codec (TIA/EIA/IS-127-1) |
| FDFCP | Full-Duplex Floor Control Proxy |
| FDP | Full-Duplex PoC |
| FDPP | Full-Duplex PoC Proxy |
| FDUE | Full-Duplex User Equipment |
| IMS | IP Multimedia Subsystem |
| IP | Internet Protocol |
| ISUP | ISDN User Part |
| IVR | Interactive Voice Response |
| IVREPA | Interactive Voice Response with Presence Event |
| | Publication Agent |
| MB | Media Buffer |
| MGC | Media Gateway Controller |
| MRFC | Media Resource Function Controller |
| MRFP | Media Resource Function Processor |
| OMA | Open Mobile Alliance |
| PoC | Push-to-talk Over Cellular |
| PSTN | Public Switched Telephony Network |
| PTT | Push-To-Talk |
| RTCP | Real-time Transport Control Protocol |
| RTP | Real-time Transport Protocol |
| SDP | Session Description Protocol |
| SG | Signaling Gateway |
| SIP | Session Initiation Protocol |
| STP | Signal Transfer Point |
| TAG | Tone/Announcement Generator |
| UE | User Equipment |
| URI | Universal Resource Indicator |
| VAD | Voice Activity Detection |
| WebLMS | Web List Management Server |

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention. As another example, reference is made to SIP and RTP Protocol but other protocols can be used in the invention. Likewise, reference is made to PTT calls, while the present invention can be applied to other types of VOIP calls with strict floor control procedures.

### A. Overview

Currently, PTT-enabled devices and PoC Servers include software that implements floor control mechanisms to ensure that, in a multi-party PoC session, only one PTT-enabled device has access to the floor at a given time. A PoC server that is implemented in accordance with a preferred embodiment, also implements mechanisms to allow non-PTT enabled devices (i.e. full-duplex devices) to participate in a PoC session as well.

Embodiments described herein provide at least two options to enable a non-PTT enabled device to participate in a PoC session without the need for additional software or hardware upgrades to existing handsets and terminals:

*Keypad activated floor control (digit map): A non-PTT enabled device may use certain pre-defined key sequences to request floor control. Key sequences may be configured to generate DTMF signals that are collected as digit-maps. Digit maps may then provide a basis to generate a floor request within the PoC Server. In some embodiments, a PoC Server may be further configured to play a tone or announcement to the non-PTT enabled device to indicate floor control changes.

*Voice activated floor control: In a PoC session, when a non-PTT enabled device is used, speech is detected at the PoC server and may be interpreted, in an embodiment, as an implicit floor request. The PoC server may be configured to recognize the non-PTT enabled device, and to invoke additional mechanisms to provide floor control based on voice activity detection. In some embodiments, a PoC Server may be further configured to play a tone or announcement to the non-PTT enabled device to indicate floor control changes.

The above methods for floor control may be utilized solely or in combination without limitation and without departing from the present invention.

### B. Systems

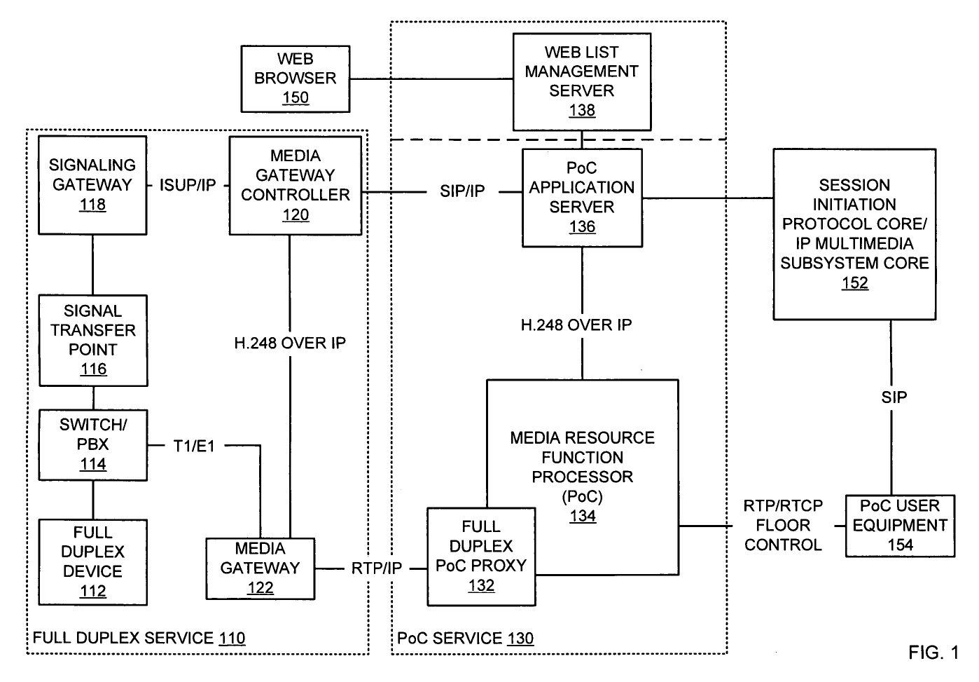

FIG. 1 is a block diagram of a network configuration for establishing a PoC session between a circuit-switched full-duplex telephony service 110 and a half-duplex conferencing PoC service 130. Typically, PoC services are limited to half-duplex compatible systems. As noted above, half-duplex systems generally utilize a single frequency for communications between user devices. As such, a single frequency may be utilized to send or to receive, but not at the same time. In contrast, full-duplex systems generally utilize two frequencies—one to send and one to receive. FIG. 1 illustrates use of a full-duplex device 112 such as a PSTN or mobile circuit-switched phone for example. In some examples, full-duplex service may also be referred to as a “Circuit Switched Telephony Endpoint.”

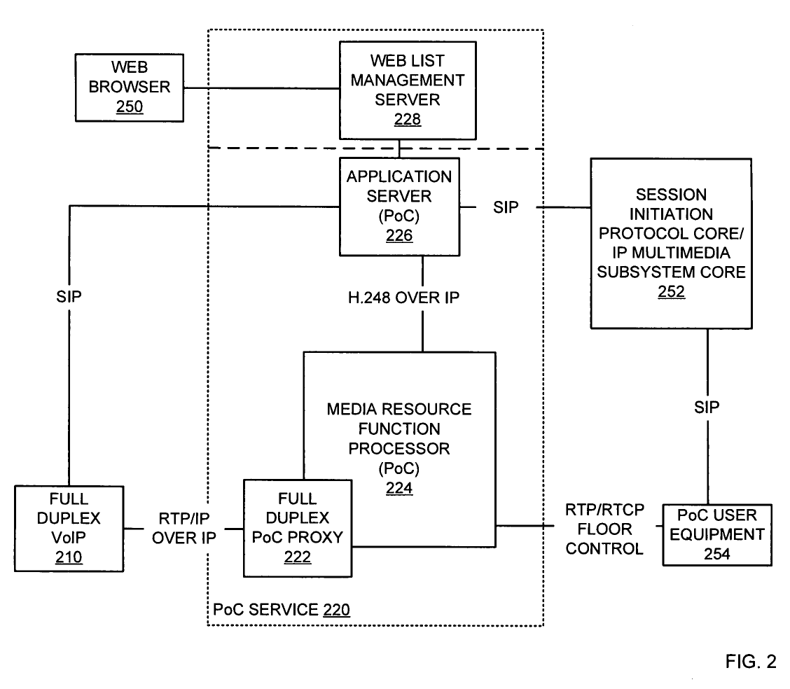

Full-duplex device 112 may, in some embodiments, be modeled as a Manual Answer Mode terminal in the PoC Application Server with a registered Tel and SIP URI. At least one reason for modeling the device as a Manual Answer Mode terminal is because a non-PTT enabled device typically does not have the capability for barge calling (e.g. auto answer mode). Furthermore, a non-PTT enabled device may require a telephone number inside the Tel URI in order to be routed correctly over circuit-switched networks. As may be appreciated, a full-duplex service 110 may include a switch or PBX component 114, a signal transfer point 116, and a signaling gateway 118. In addition, a Media Gateway Controller (MGC) 120 for providing an interface for control signals to pass between full-duplex service 110 and PoC service 130. In addition, MGC 120 may be further configured to provide a control interface for Media Gateway 122, where Media Gateway 122 is configured to provide and receive control streams and media streams. As illustrated, Media Gateway 122 may be utilized to provide an interface to a PoC environment utilizing embodiments of the present invention. Thus, for example, in case of a circuit-switched user initiated call, MGC 120 maps a circuit-switched ISUP signaling into PoC compliant SIP signaling for use in a PoC environment. At least a portion of this mapping includes translating the calling and called party phone number to a Tel-URI or a SIP URI that may be utilized for routing within SIP. This may be done by combining a specific domain name with a telephone number (e.g. <tel_num@domain_name>=14153313492@mgc.com). MGC 120 may be configured to instruct Media Gateway 122 to make a mapping at the user plane of a T1/E1 channel to a RTP/RTCP stream, because Full-Duplex PoC Proxy (FDPP) 132 in the PoC MRFP 134 only can terminate the latter. In case of a VOIP phone, the TEL-URI or the SIP-URI may be sent directly to a PoC Application server 136 using SIP, as described for FIG. 2 below.

PoC Application Server 136 may be configured to receive a SIP INVITE from MGC 120 and to detect whether a call originates from a non-PTT enabled calling system or a VOIP device by, for example, detecting a missing PoC Compliant User Agent header in a received SIP signaling message. If a SIP INVITE contains a TEL-URI to represent the called party, PoC Application Server 136 queries an internal database or an external DNS ENUM server to convert the Tel-URI to a routable SIP URI within the PoC infrastructure where necessary. In another example, where a pre-arranged group is called, PoC Application Server 136 may be configured to utilize a List Management Server (not shown as a separate entity) to determine which PoC Users and Full-Duplex Users should be invited to a conference session.

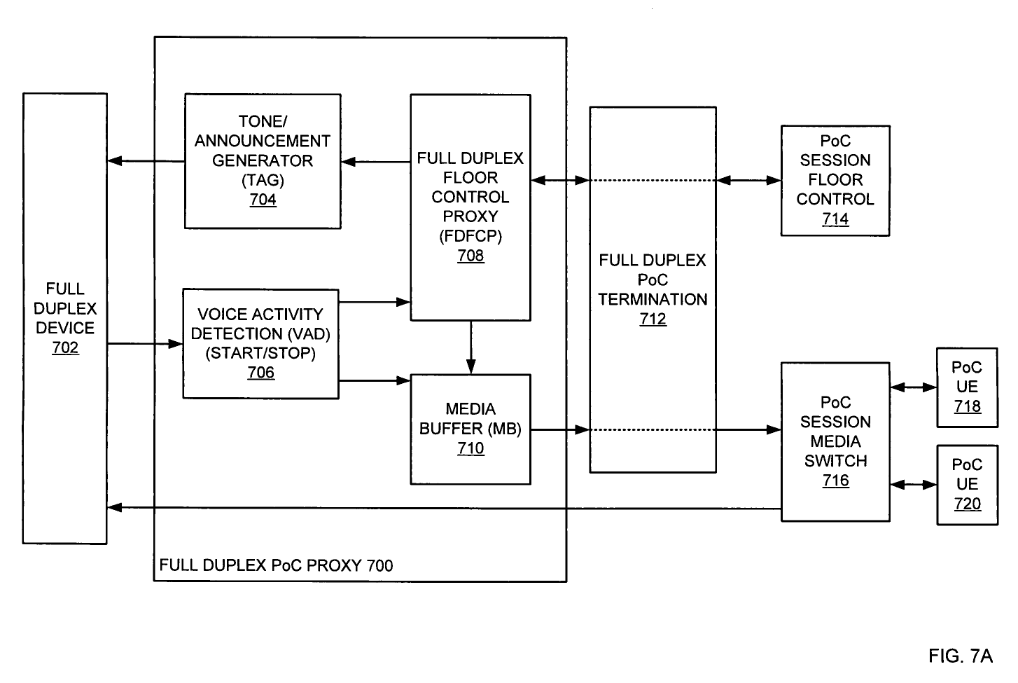

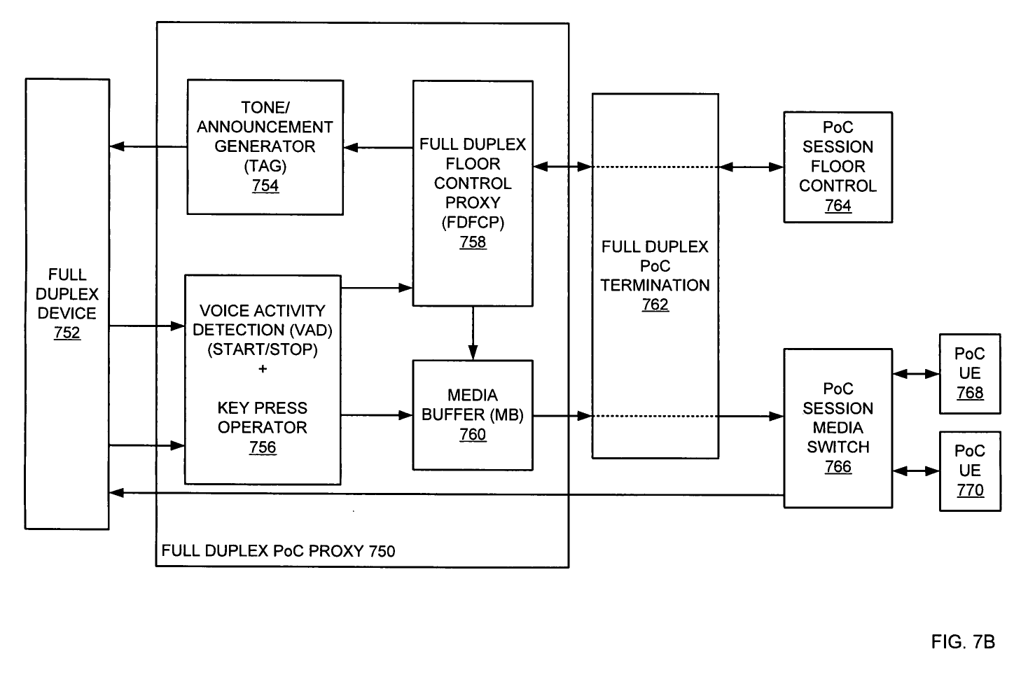

After successfully contacting desired participants, PoC Application Server 136 may instruct PoC MRFP 134 to establish a number of PoC termination points for connecting a number of PoC users such as PoC user 154 via SIP/IMS 152. For full-duplex devices, a special termination endpoint called a Full-Duplex PoC Termination may be created. A Full-Duplex PoC Termination is associated with FDPP 132, which may be configured to perform voice activity detection as well as to send tones and announcements. FDPP will be discussed in further detail below for FIG. 7A. FDPP 132 may also be configured to generate floor control messages and to process any floor control messages received. FDPP 132 may be further configured to transcode wireline codecs (for non-PTT enabled devices), such as G.711 or G.723, into wireless PoC codecs (for PTT enabled devices), such as EVRC or AMR, for example. In some embodiments, a user with a non-PTT enabled device may also find PoC groups and PoC user addresses via mechanisms such as a PoC Application Server's Web List Management Server (WebLMS) 138, which may be accessed via web enabled browser 150. In some embodiments, web enable browser 150 may be configured to publish addresses and presence information associated with the PoC session to non-PTT enabled devices. As such, a non-PTT enabled device may be enabled to: receive calls from PoC users, initiate group calls to PoC users, and initiate one-to-one calls to PoC users.

FIG. 2 is a block diagram of a network configuration for SIP Voice over IP (VOIP) full-duplex endpoint to half-duplex conferencing PoC endpoint. As illustrated, a MGC (120; FIG. 1) and a Media Gateway (122; FIG. 1) are not required. The functionality for the PoC Application Server and MRFP/FDPP is, however, substantially the same as depicted in FIG. 1. As such, PoC Application Server 226 may be configured to receive a SIP INVITE from VOIP device 210 and to detect whether a call originates from a non-PTT enabled calling system or from a VOIP device by, for example, detecting the lack of a PoC User Agent header. If a SIP INVITE contains a TEL-URI to represent the called party, PoC Application Server 226 queries an internal database or an external DNS ENUM server to convert the Tel-URI to a routable SIP URI within the PoC infrastructure if necessary. In another example, where a pre-arranged group is called, PoC Application Server 226 may be configured to utilize a List Management Server (not shown as a separate entity) to determine which PoC Users and Full-Duplex Users should be invited to a conference session.

After successfully contacting desired participants, PoC Application Server 226 may instruct PoC MRFP 224 to establish a number of PoC termination points for connecting a number of PoC users such as PoC user 254 via SIP/IMS 252. For full-duplex devices, a special termination endpoint called a Full-Duplex PoC Termination may be created. FDPP 222 may also be configured to generate floor control messages and to process any floor control messages received. FDPP will be discussed in further detail below for FIG. 7A. FDPP 222 may also be configured to generate floor control messages, and to process any floor control messages received. FDPP 2322 may be further configured to transcode wireline codecs, such as G.711 or G.723, into wireless PoC codecs, such as EVRC or AMR, for example. In some embodiments, a user with a non-PTT enabled device may also find PoC groups and PoC user addresses via mechanisms such as a PoC Application Server's Web List Management Server (WebLMS) 228, which may be accessed via web browser 250. As such, a non-PTT enabled device may be enabled to: receive calls from PoC users, initiate group calls to PoC users, and initiate one-to-one calls to PoC users.

### Presence

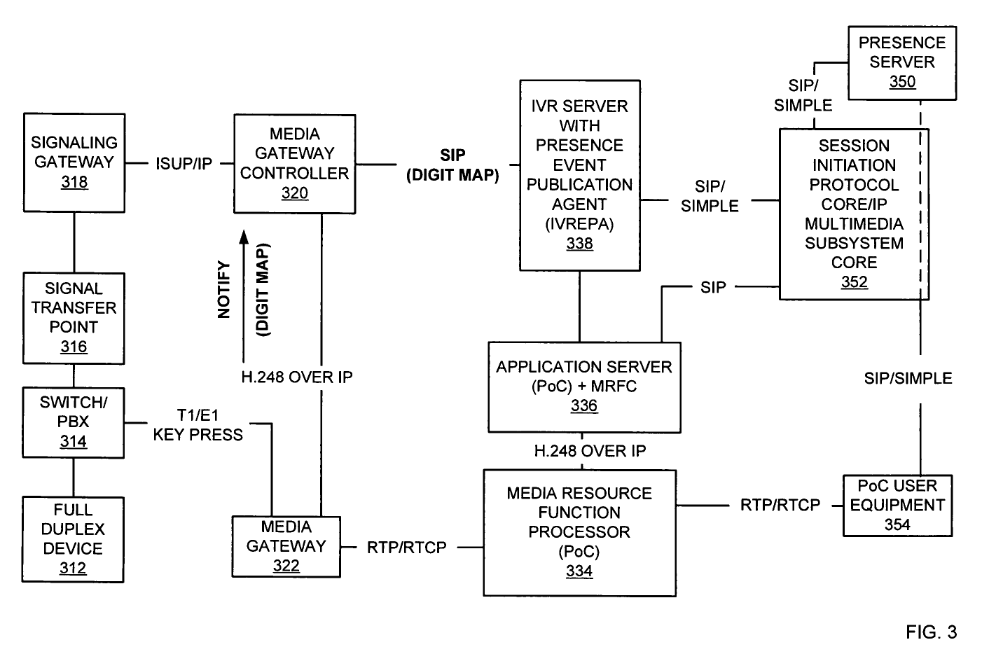

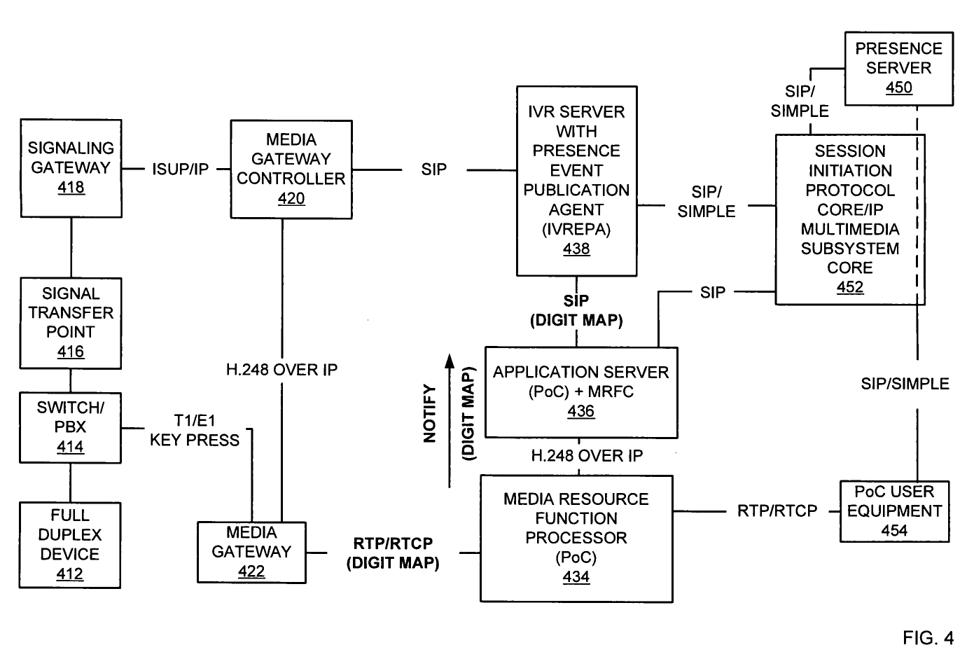

In some embodiments, a PoC device is capable of displaying the presence status of a particular user in a member list. Presence information of each member is obtained from a Presence Server configured to publish such information. In the PoC Consortium specification, a Presence Server is an integral part of the PoC service. All presence aware PoC devices publish their presence status to a presence server. A device that is not presence aware or is not PTT enabled has no means by which to publish presence information. To resolve this, a user with a non-PTT enabled device may connect with a PoC service that includes a presence aware Interactive Voice Response (IVR) server, which allows a user to publish PTT specific presence status. IVR with Presence Event Publication Agent 338/438 (IVREPA) functional block in FIGS. 3 and 4 represents such an IVR server.

FIG. 3 is a block diagram of a network configuration for establishing a PoC session between a circuit-switched full-duplex telephony service and a half-duplex conferencing PoC service that includes a presence server 350. When a user having a full-duplex device 312 wishes to allow other presence aware PTT users (e.g. 354) access to presence information, the full-duplex device 312 may connect with IVREPA 338. IVREPA 338 may be configured to prompt a user to enter a predefined key sequence (or give voice commands) in order to change user presence status. The Presence Event Publication Agent component of the IVREPA 338 may then interact with presence server 350 to update presence status on behalf of the non-presence aware user (i.e. Full-Duplex Device 312).

In some embodiments, a presence server may be configured to detect a presence signal such as, for example, a signal generated from a key selection or sequence on a non-PTT enabled device during a full-duplex call to an IVREPA, or a signal generated by a home location register/visitor location register on behalf of a non-PTT enabled device. Interactions between IVREPA 338 and presence server 350 may be accomplished using any suitable mechanisms and protocols well-known in the art without departing from the present invention, including for example, specialized network equipment to map DTMF signals to Presence SIMPLE protocol messages. Thus, as illustrated in FIG. 3, digit collection may occur at MGC 320. Thus, IVREPA 338 receives responses (key presses or user voice commands) from a full-duplex device (i.e. circuit switched device), and maps them to a message for the presence server that specifies the user's presence status. In case of IMS and OMA compliant Push to Talk systems, a SIP PUBLISH may be sent to the presence server via a SIP core (or IMS core).

In a preferred embodiment, IVREPA 338 is implemented in accordance with IETF RFC 2833 “RTP Payload for DTMF Digits, Telephony Tones”, which is hereby incorporated by reference in its entirety. In another preferred embodiment, IVREPA 338 further implements an Event Publication Agent for publishing presence status of a full-duplex UE based on procedures defined in “Presence SIMPLE Specification”, Candidate Version 1.0—27 Apr. 2005, Open Mobile Alliance, OMA-TS-Presence_SIMPLE-V1_{—}0-20050427-C, and in “Session Initiation Protocol (SIP) Extension for Event State Publication” (RFC3903), which is hereby incorporated by reference in its entirety. As may be appreciated, in a GSM network, Presence Server 350 can also retrieve the availability status for a mobile phone automatically by querying the Home Location Register and Mobile Switching Center. This alleviates the need for the circuit-switched mobile phone user to utilize the IVR capability described above.

FIG. 4 is a block diagram of a network configuration for establishing a PoC session between a circuit-switched full-duplex telephony service and a half-duplex conferencing PoC service that includes a presence server 450. When a user having a full-duplex device 412 wishes to allow other presence aware PTT users (e.g. 454) access to presence information, the full-duplex device 412 may connect with IVREPA 438. IVREPA 438 may be configured to prompt a user to enter a predefined key sequence (or give voice commands) in order to change user presence status. The Presence Event Publication Agent component of the IVREPA 438 may then interact with the presence server 450 to update presence status on behalf of the non-presence aware user (i.e. Full-Duplex Device 412). Interactions between IVREPA 438 and presence server 450 may be accomplished using any suitable mechanisms and protocols well-known in the art without departing from the present invention, including for example, specialized network equipment to map DTMF signals to Presence SIMPLE protocol messages. Thus, as illustrated in FIG. 4, digit collection may occur at MRFP 434. Digits collected may be sent to MRFP 434 using mechanisms such as those defined in IETF RFC 2833 (RTP Payload for DTMF Digits, Telephony Tones and Telephony Signals), which is hereby incorporated by reference in its entirety. Thus, IVREPA 438 receives responses (key presses or user voice commands) from a full-duplex device (i.e. circuit switched device), and maps them to a message for the presence server that specifies the user's presence status. In case of IMS and OMA compliant Push to Talk systems, a SIP PUBLISH may be sent to the presence server via a SIP core (or IMS core).

In a preferred embodiment, IVREPA 438 is implemented in accordance with IETF RFC 2833 “RTP Payload for DTMF Digits, Telephony Tones”, which is hereby incorporated by reference in its entirety. In another preferred embodiment, IVREPA 438 further implements an Event Publication Agent for publishing presence status of a Full-Duplex UE based on procedures defined in “Presence SIMPLE Specification”, Candidate Version 1.0—27 Apr. 2005, Open Mobile Alliance, OMA-TS-Presence_SIMPLE-V1_{—}0-20050427-C, and in “Session Initiation Protocol (SIP) Extension for Event State Publication” (RFC3903), which is hereby incorporated by reference in its entirety. As may be appreciated, in a GSM network, Presence Server 450 can also retrieve the availability status for a mobile phone automatically by querying the Home Location Register and Mobile Switching Center. This alleviates the need for the circuit-switched mobile phone user to utilize the IVR capability described above.

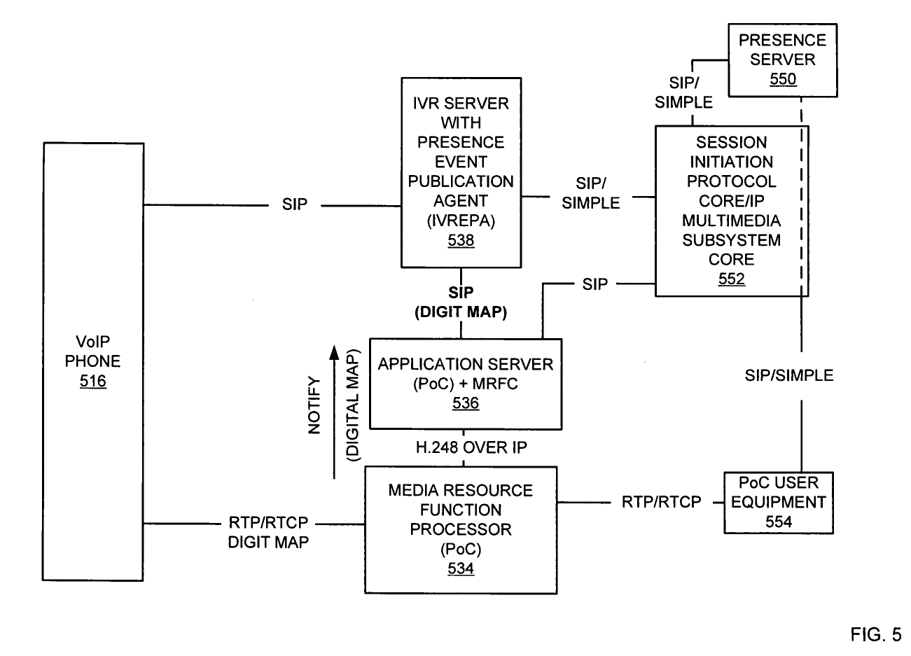

FIG. 5 is a block diagram of a network configuration for establishing a PoC session between a VOIP device 516 and a half-duplex conferencing PoC service that includes a presence server 550. When a user having VOIP device 516 wishes to allow other presence aware PTT users (e.g. 554) access to presence information, VOIP device 516 may connect with IVREPA 538. IVREPA 538 may be configured to prompt the user to press a predefined sequence of keys (or give voice commands) in order to change user presence status. The Presence Event Publication Agent component of IVREPA 538 may then interact with presence server 550 to update presence status on behalf of the non-presence aware user. Interactions between IVREPA 538 and presence server 550 may be accomplished using any suitable mechanisms and protocols well-known in the art without departing from the present invention, including for example, specialized network equipment to map DTMF signals to Presence SIMPLE protocol messages. Thus, as illustrated in FIG. 5, digit collection may occur at MRFP 534. Digits collected may be sent to MRFP 534 using mechanisms such as those defined in IETF RFC 2833 (RTP Payload for DTMF Digits, Telephony Tones and Telephony Signals), which is hereby incorporated by reference in its entirety. Thus, IVREPA 538 may receive responses (key presses or user voice commands) from a VOIP device, and maps them to a message for the presence server that specifies the user's presence status. In case of IMS and OMA compliant Push to Talk systems, a SIP PUBLISH may be sent to the presence server via a SIP core (or IMS core).

In a preferred embodiment, IVREPA 538 is implemented in accordance with IETF RFC 2833 “RTP Payload for DTMF Digits, Telephony Tones”, which is hereby incorporated by reference in its entirety. In another preferred embodiment, IVREPA 538 further implements an Event Publication Agent for publishing presence status of a Full-Duplex UE based on procedures defined in “Presence SIMPLE Specification”, Candidate Version 1.0—27 Apr. 2005, Open Mobile Alliance, OMA-TS-Presence_SIMPLE-V1_{—}0-20050427-C, and in “Session Initiation Protocol (SIP) Extension for Event State Publication” (RFC3903), which is hereby incorporated by reference in its entirety.

### Media Resource Function Processor

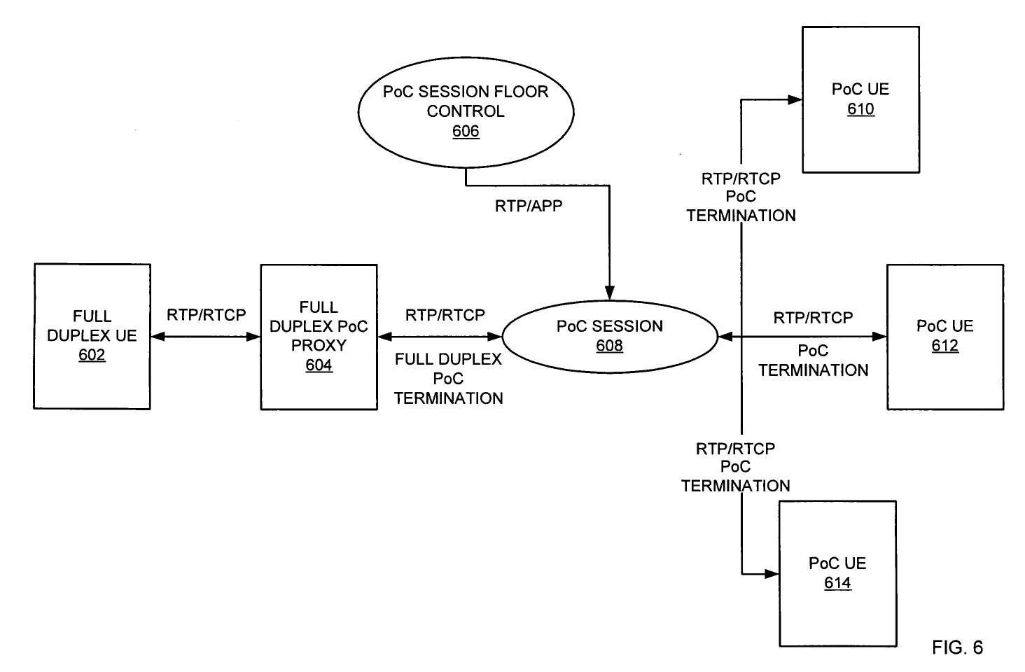

FIG. 6 is block diagram of a PoC session 608 representation within a Media Resource Function Processor (MRFP) that includes Full-Duplex PoC termination in accordance with an embodiment of the present invention. Thus, when a Full-Duplex UE 602 participates in a PoC Session 608 having any number of half-duplex PoC UE's 610/612/614, a PoC Server may be configured to add a distinct termination in the PoC Session 608 context within the MRFP component of the PoC server. This distinct termination may be referred to as Full-Duplex PoC (FDP) termination. FDP Termination may be configured to function as a “gateway” between a Full-Duplex user 602, and any number of half-duplex PoC UE's 610/612/614. FDP Termination may be configured to invoke mechanisms that communicate and negotiate with PoC session floor control 606 through the use of tones or announcements by a Full-Duplex UE 602. Tones and announcement may be further configured to provide the current state of PoC session floor to a full-duplex user. FDP Termination is a logical entity within PoC Session 608 and is physically realized by a Full-Duplex PoC Proxy (FDPP) 604, which provides at least the following functions: Voice Activity Detection (VAD); Full-Duplex Floor Control Proxy (FDFCP); Media buffering (MB) from the Full-Duplex (FD) user; and Tone/Announcement Generator (TAG), but may also optionally perform other tasks such as transcoding. The main functions of an example FDPP will now be described below.

### Full-Duplex PoC Proxy

FIG. 7A is a functional block diagram of the Full-Duplex PoC Proxy (FDPP) 700 with voice activity detection for floor control in accordance with an embodiment of the present invention. As may be appreciated, embodiments of FDPP 700 may be configured to provide an interface for both control streams and media streams to pass between FDDP 700 and FDP Termination 712 as implemented in a PoC Service. FDPP 700 implements a Voice Activity Detection (VAD) 706 component that detects the start of speech signal and the end of speech signal for each full-duplex device 702. When VAD 706 detects speech, it invokes a Full-Duplex Floor Control Proxy (FDFCP) 708, acting on behalf of full-duplex device 702 towards the PoC Session. Once floor control is granted or revoked, FDFCP 708 instructs Tone/Announcement Generator (TAG) 704 to send an announcement to full-duplex device 702. Furthermore, the FDPP 700 may be configured to send any packets that may have been aggregated in Media Buffer 710 during a floor control request procedure if floor control is granted. If a floor request is denied by the PoC server, all packets in Media Buffer 710 are discarded. FDP Termination 712 provides a logical communication path between FDPP 700 and several PoC components namely, PoC Session Floor Control 714 and PoC Session Media Switch 716. As may be appreciated, any number of PoC UE's 718/720 may be connected with full-duplex device 702 using embodiments described herein. FDPP 700

FIG. 7B is a functional block diagram of the Full-Duplex PoC Proxy (FDPP) 750 further configured with key press processing for floor control in accordance with an embodiment of the present invention. As may be appreciated, certain pre-defined keys or key sequences may be utilized by full-duplex device 752 (e.g., circuit switched or VOIP) to generate floor control requests. Further, as noted above, embodiments of FDPP 750 may be configured to provide an interface for both control streams and media streams to pass between FDDP 750 and FDP Termination 762 as implemented in a PoC Service. Thus, FDPP 750 implements a Voice Activity Detection (VAD) and Key Press Operator (KPO) 756 mechanism that detects start and end of speech for each full-duplex device 752 and provides for processing key sequences utilized to initiate floor control operations. As noted above, when VAD/KPO 756 detects speech or key sequences, it invokes a Full-Duplex Floor Control Proxy (FDFCP) 758, acting on behalf of full-duplex device 752 towards the PoC Session. Once floor control is granted or revoked, FDFCP 758 instructs Tone/Announcement Generator (TAG) 754 to send an announcement to full-duplex device 702. Further, VAD/KPO 756 may be configured to receive key sequences. A digit map corresponding to a key sequence may be sent to the PoC server FDPP 750 using any suitable mechanism that may involve in-band, or out-of band signaling. Mechanisms defined in IETF RFC 2833 (RTP Payload for DTMF Digits, Telephony Tones and Telephony Signals), which is hereby incorporated by reference in its entirety, may be used for transmission of key sequences to FDPP 750. As such, FDPP 750 may be configured to implement a key sequence processor.

A key sequence processor terminates all RTP packets carrying the DTMF digits, and identifies a floor control message from a full-duplex device 752. The key sequence processor then uses FDFCP 758 to send an appropriate floor control message to the PoC session via FDP Termination 762. Depending on the current floor state, the PoC session generates an appropriate response to the floor control message at PoC session floor control component 764. The response may be then sent to FDFCP 758 via FDP Termination 762. FDFCP 758 identifies the floor control message received from the PoC session, and generates an appropriate tone or announcement using TAG 754, as described above. Alternatively, a digit map may be sent to FDPP 750 using any other suitable protocol, e.g. SIP and H.248 via the PoC Application Server. Thus, a key sequence processor may map a digit map to an appropriate floor control message as described above. Furthermore, the FDPP 750 may be configured to send any packets that may have been aggregated in Media Buffer 760 during a floor control request procedure if floor control is granted. If a floor request is denied by the PoC server, all packets in Media Buffer 760 are discarded. As may be appreciated, any number of PoC UE's 768/770 may be connected with full-duplex device 752 using embodiments described herein.

### C. Example Methods

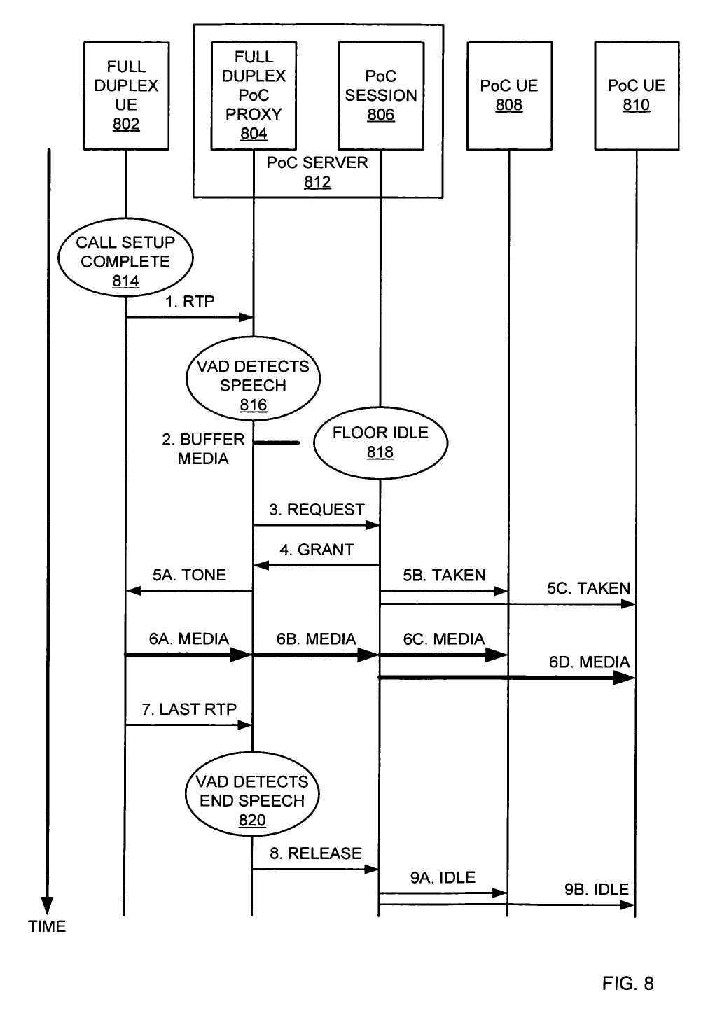

FIG. 8 is a sequence flow diagram depicting message flow when a Full-Duplex UE activates floor control by speaking where the current floor control state is IDLE in accordance with an embodiment of the present invention. The example session includes a Full-Duplex User Equipment (FDUE) 802 connected with two PoC UE's 808/810 using a PoC server 812. In one embodiment, PoC server 812 includes Full-Duplex PoC Proxy (FDPP) 804 and PoC session 806. It is, however, possible to use the preferred embodiment for multiple FDUEs. Once call setup has been completed 814 using, for example, embodiments described herein, the system is ready to receive user input. At the start of speech by FDUE 802, an RTP packet (step 1) is detected as a start of speech signal 816 and is interpreted as a request for permission to speak in the FDPP 804. Because a floor request causes at least some lag in processing, speech (in the form of RTP packets) may be buffered in a media buffer (step 2). If the floor control state is IDLE 818 as indicated by PoC session 806, a FLOOR REQUEST (i.e. floor control request) generated and sent (step 3) to an RTCP port designated for floor control for this particular Full-Duplex PoC (FDP) Termination within the PoC Session 806.

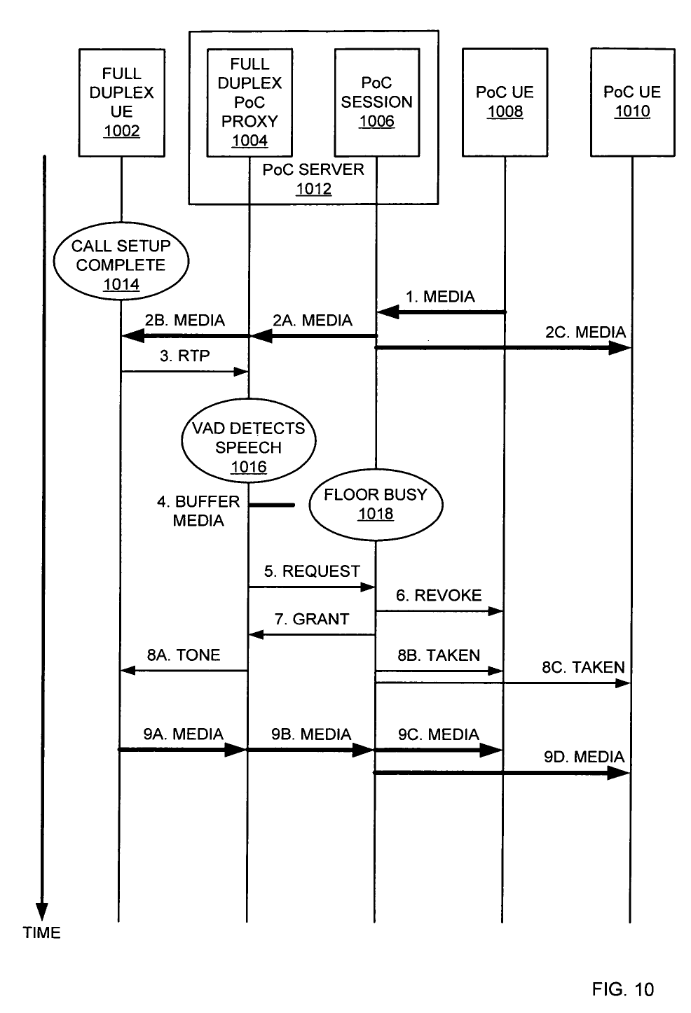

The FLOOR REQUEST is analyzed by the PoC floor control state machine of the PoC session 806, and depending on the floor state, an appropriate floor control response message (FLOOR GRANT or FLOOR DENY) is sent (step 4) back to the FDP Termination. The FDP Termination directs this floor control response to FDPP 804. FDPP 804 may map the floor control response message received from the PoC session floor control state machine to a specific tone, or announcement corresponding to that floor control response message, and send (step 5A) the tone or announcement to FDUE 802. A FLOOR TAKEN (i.e. floor control status) signal may also be sent to PoC users 808 and 810 (steps 5B-C). In one embodiment, if the PoC session floor control mechanism grants FDUE 802 permission to speak, then a Full-Duplex Floor Control Proxy (FDFCP) may provide an announcement such as, “Please begin speaking now” for FDUE 802. Note that this announcement may not be required in an example where a non-PTT enabled device is configured as a priority user within the PoC session. In that example, the non-PTT enabled device may be configured to always receive the floor in response to a FLOOR REQUEST (see FIG. 10 for a more detailed explanation of priority handling within a PoC Session). Also note that any appropriate announcement may be utilized without departing from the present invention.

In some embodiments, a Media Buffer in the FDPP 804 may contain buffered media received from FDUE 802 during floor control procedures. After a FLOOR GRANT message is received by FDPP 804, buffered media may be sent to all the members of the session (steps 6A-D). Furthermore, in some embodiments, the Media Buffer may be configured to perform speech pitch attenuation in order to compress speech duration so that multiple media streams may be synchronized to some extent. This feature is particularly useful where multiple non-PTT enabled users are in conference together.

In one embodiment, FDPP 804 may be configured to detect end of speech. For example, once all media has been sent to all users (step 7), a Voice Activity Detection (VAD) component in FDPP 804 may detect end of speech (i.e. silence) 820. When end of speech is detected, an FDFCP component in FDPP 804 may send a FLOOR RELEASE (i.e. floor control release) message (step 8) to an FDP Termination. The FLOOR RELEASE message may also be received by a PoC Session Floor Control State Machine, which may be configured to set the floor control state of the PoC Session to IDLE (steps 9A-B) in response to the FLOOR RELEASE message. As may be appreciated, end of speech detection may be implemented in any number of methods without departing from the present invention. For example, in an embodiment, a timer may be configured to trigger a FLOOR RELEASE in response to silence over a specified interval of time. In some embodiments, intervals may include a selectable minimum and maximum value. VAD components, as contemplated herein, may further include background noise filtering.

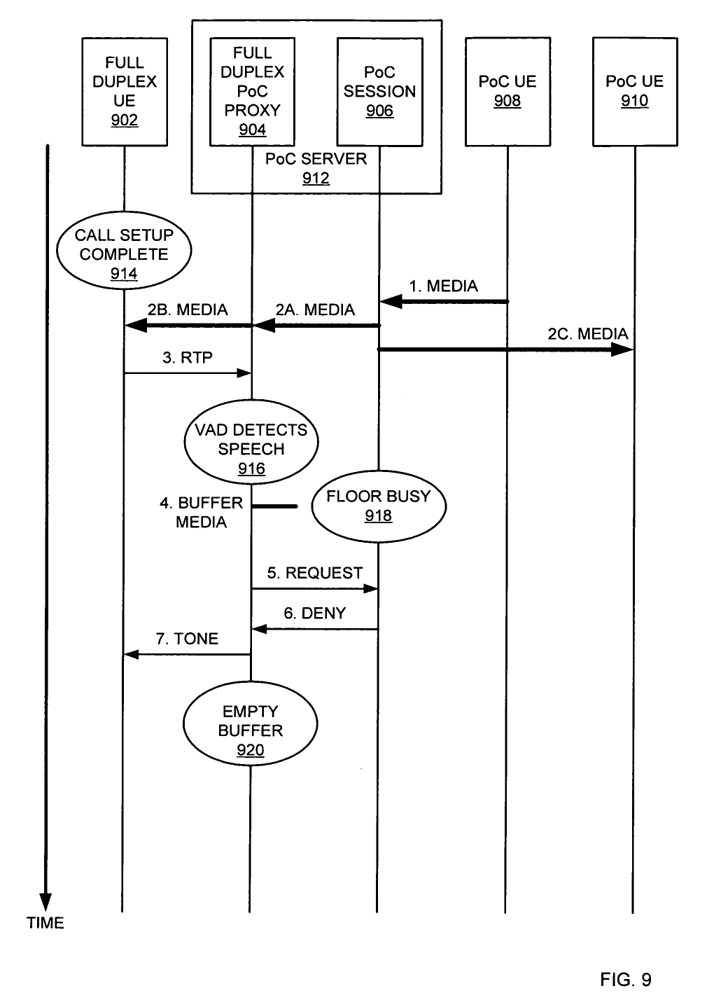

FIG. 9 is a data flow diagram depicting message flow when a Full-Duplex LE begins speaking where floor control state is not IDLE and the Full-Duplex LE is not a priority user in accordance with an embodiment of the present invention. As illustrated, Full-Duplex User Equipment (FDUE) 902, PoC UE 908, and PoC UE 910 are participating in a PoC session over a PoC server 912. In one embodiment, PoC server 912 includes Full-Duplex PoC Proxy (FDPP) 904 and PoC session 906. In the illustrated example, after call setup is complete 914, PoC UE 908 takes the floor and begins speaking (step 1). In response to PoC UE's 908 speech, media is streamed to FDUE 902 and to PoC UE 910 (steps 2A-C). During media streaming, FDUE 902 interrupts by speaking (step 3). Media from FDUE 902 enters PoC Server 912 and is directed to FDPP 904, where a VAD component detects a start of speech signal 916. Media may be buffered (step 4) while floor negotiation continues. VAD activates the Full-Duplex Floor Control Proxy (FDFCP), which in turn directs a FLOOR REQUEST (i.e. floor control request) (step 5) to a Full-Duplex PoC (FDP) Termination of PoC session 906. The FLOOR REQUEST is then directed to a PoC session floor control state machine. The PoC session floor control state machine determines that the floor control state is NOT IDLE 918, and, in some embodiments determines whether FDUE 902 has a higher device priority than PoC UE 908, who currently has the floor. As may be appreciated, device priority may be a user configurable parameter in some embodiments. In the example illustrated, FDUE 902 has a lower or equal device priority than PoC UE 908, so the PoC session floor control state machine generates a FLOOR DENY message (step 6), and directs the message to FDPP 904. In some embodiments, a FLOOR DENY message may contain an information code that explains why a FLOOR REQUEST was denied. When FDUE's 902 is denied permission to speak, FDPP 904 may be configured to play a corresponding tone or announcement (step 7) for FDUE 902. Further, any buffered media remaining in the Media Buffer 920 from FDUE 902 (step 4) is discarded by the FDPP 904.

FIG. 10 is a data flow diagram depicting message flow when a Full-Duplex UE begins speaking where floor control state is not IDLE and the Full-Duplex UE is a high priority user in accordance with an embodiment of the present invention. It may be appreciated that FIG. 10 displays a substantially similar conditions such as those illustrated in FIG. 9. The principle difference is that the FDUE 1002 is configured with higher device priority than PoC UE 1008.

As illustrated, Full-Duplex User Equipment (FDUE) 1002, PoC UE 1008, and PoC UE 1010 are participating in a PoC session over a PoC server 1012. In one embodiment, PoC server 1012 includes Full-Duplex PoC Proxy (FDPP) 1004 and PoC session 1006. After call setup is complete 1014, PoC UE 1008 takes the floor and begins speaking (step 1). In response to PoC UE's 1008 speech, media is streamed to FDUE 1002 and to PoC UE 1010 (steps 2A-C). During media streaming, FDUE 1002 interrupts by speaking (step 3). Media from FDUE 1002 enters PoC Server 1012 and is directed to FDPP 1004, where a VAD component detects a start of speech signal 1016. Media may be buffered (step 4) while floor negotiation continues. VAD activates the Full-Duplex Floor Control Proxy (FDFCP), which in turn directs a FLOOR REQUEST (i.e. floor control request) (step 5) to a Full-Duplex PoC (FDP) Termination of PoC session 1006. The FLOOR REQUEST is then directed a PoC session floor control state machine. The PoC session floor control state machine determines that the floor control state is NOT IDLE 1018, and, in some embodiments determines whether FDUE 1002 has a higher device priority than PoC UE 1008. In the example illustrated, FDUE 1002 has a higher device priority than PoC UE 1008, so the PoC session floor control state machine generates a FLOOR REVOKE message, (step 6) and directs the message to PoC UE 1008. A FLOOR GRANT message (step 7) may then be directed to FDPP 1004. FDPP 1004 may be configured to play a corresponding tone or announcement (step 8A) for FDUE 1002 to indicate permission to speak. A FLOOR TAKEN message (steps 8B-C) may be further directed to PoC UE's 1008 and 1010. In some embodiments, a wait interval may be configured to stall a FLOOR REVOKE so that a user may finish speaking. Once FDUE 1002 receives permission, media may then be streamed to all participants (steps 9A-D)

### D. Conclusion

While this invention has been described in terms of several embodiments, there are alterations, permutations, and equivalents, which fall within the scope of this invention. It should also be noted that there are many alternative ways of implementing the methods and apparatuses of the present invention. For example, although the illustrations provided herein show one full-duplex device, many more are contemplated and are, therefore within the scope of the presenting invention. It is therefore intended that the following appended claims be interpreted as including all such alterations, permutations, and equivalents as fall within the true spirit and scope of the present invention.

What is claimed is:

1. A method of enabling at least one non-Push-To-Talk (PTT) enabled device, the at least one non-PTT enabled device configured for full-duplex communication, to participate in a PTT-over-Cellular (PoC) session wherein the PoC session includes at least one PTT enabled device, comprising the steps of:
detecting a start of speech signal from the at least one non-PTT enabled device;
generating a floor control request on behalf of the at least one non-PTT enabled device;
negotiating the floor control request based on a device priority;
generating a floor control response for the at least one non-PTT enabled device; and
generating a first floor control state for the PoC session.

2. The method of claim 1 further comprising:
buffering a plurality of RTP packets in a media buffer, the plurality of RTP packets corresponding to speech received from the at least one non-PTT enabled device;
if the floor control request is granted, sending the plurality of RTP packets to the PoC session; and
if the floor control request is denied, discarding the plurality of RTP packets.

3. The method of claim 2 further comprising:
detecting an end of speech signal from the at least one non-PTT enabled device;
generating a floor control release on behalf of the at least one non-PTT enabled device; and
generating a second floor control state for the PoC session.

4. The method of claim 1 wherein the start of speech signal is selected from the group consisting of: a signal generated from at least one key selection on the at least one non-PTT enabled device, and a signal generated from a Voice Activity Detection component coupled with the at least one non-PTT enabled device.

5. The method of claim 1 wherein the device priority is configurable parameter for each of the at least one non-PTT enabled devices and for each of the at least one PTT enabled devices.

6. The method of claim 1 wherein the generating a first floor control state for the PoC session includes generating an announcement for the at least one non-PTT enabled device.

7. The method of claim 1 wherein the generating a first floor control state for the PoC session includes generating a tone for the at least one non-PTT enabled device.

8. The method of 2 wherein the sending the plurality of RTP packets to the PoC session includes performing speech pitch attenuation such that the sending the plurality of RTP packets is synchronized.

9. The method of claim 3 wherein the end of speech signal is selected from the group consisting of: a first signal generated from at least one key selection on the at least one non-PTT enabled device, and a second signal generated from a Voice Activity Detection component coupled with the at least one non-PTT enabled device.

10. The method of claim 9 wherein the Voice Activity Detection component includes a timer such that the end of speech signal corresponds to an interval of silence over a selected time interval.

11. The method of claim A1 wherein the at least one non-PTT enabled device in the PoC session is detected by a missing PoC Compliant User Agent header in a received SIP signaling message.

12. A system for enabling at least one non-Push-To-Talk (PTT) enabled device, the at least one non-PTT enabled device configured for full-duplex communication, to participate in a PTT-over-Cellular (PoC) session wherein the PoC session includes at least one PTT enabled device comprising:
a full-duplex service configured to provide access to a first communication network for the at least one non-PTT enabled device;
a PoC service configured to provide access to a second communication network for the at least one PTT enabled device;
a media gateway controller for providing an interface for a plurality of control signals to pass between the full-duplex service and the PoC service and for providing a control interface for a media gateway, the media gateway configured to provide and receive a control stream and a media stream; and
a full-duplex PoC proxy coupled with the PoC service for providing an interface for the control stream and the media stream to pass between the full-duplex service and the PoC service.

13. The system of claim 12 further comprising a presence server for publishing presence information to the at least one non-PTT enabled device and to the at least one PTT enabled device.

14. The system of claim 13 further comprising a web list management server for providing an interface between the PoC service and a web enabled browser, the web browser configured to publish a plurality of addresses and the presence information associated with the PoC session to the at least one non-PTT enabled device.

15. The system of claim 12 wherein the plurality of control signals is transported over SIP/IP.

16. The system of claim 12 wherein the media stream is transported over RTP/RTCP.

17. The system of claim 12 wherein the full-duplex PoC proxy comprises:
a voice activity detection component for detecting a speech signal from the at least one non-PTT enabled device;
a media buffer for buffering the speech signal;
a tone/announcement generator for providing tones and announcements corresponding to a floor control signal received from the PoC service to the at least one non-PTT enabled device; and
a full-duplex floor control proxy for receiving the floor control signal.

18. The system of claim 17 further comprising a key press operator for detecting a key sequence from the at least one non-PTT enabled device.

19. The system of claim 12 wherein the at least one non-PTT enabled device is selected from the group consisting of: a SIP phone, a circuit-switched PSTN phone, a circuit-switched mobile phone, and a VOIP phone.

20. The system of claim 14 wherein the presence information for the at least one non-PTT enabled device is provided by the group consisting of: the media gateway controller over SIP, and the media gateway over RTP/RTCP.

21. The system of claim 20 further comprising a presence server for publishing presence information to the at least one PTT enabled device, wherein the presence server is configured to detect a presence signal from the group consisting of: a first signal generated from at least one key selection on the at least one non-PTT enabled device during a full-duplex call to an interactive voice response server, and a second signal generated by a home location register/visitor location register on behalf of the at least one non-PTT enabled device.

22. The system of claim 17 further comprising a transcoding processor for converting speech between non-PTT enabled device codec format and PTT-enabled device codec format.

23. The system of claim 21 wherein the at least one key selection by the at least one non-PTT enabled device is detected by the group consisting of: a PoC media resource function processor over RTP/RTCP, a PoC application server over H.248, and an interactive voice response server over SIP.

24. A method of enabling at least one non-Push-To-Talk (PTT) enabled device, the at least one non-PTT enabled device configured for full-duplex communication, to participate in a PTT-over-Cellular (PoC) session wherein the PoC session includes at least one PTT enabled device, comprising the steps of:
detecting a start of speech signal from the at least one non-PTT enabled device;
buffering a plurality of RTP packets in a media buffer, the plurality of RTP packets corresponding to speech received from the at least one non-PTT enabled device;
generating a floor control request on behalf of the at least one non-PTT enabled device;
negotiating the floor control request based on a device priority;
if the floor control request is granted, sending the plurality of RTP packets to the PoC session;
if the floor control request is denied, discarding the plurality of RTP packets;
generating a floor control response for the at least one non-PTT enabled device;
generating a first floor control state for the PoC session;
detecting an end of speech signal from the at least one non-PTT enabled device;
generating a floor control release on behalf of the at least one non-PTT enabled device; and
generating a second floor control state for the PoC session.
